(19) United States
(12) Patent Application Publication
(10) Pub. No.: US 2003/0159716 A1
(43) Pub. Date: Aug. 28, 2003

(54) Wafer cleaning method

(75) Inventors: Toshihiko Nagai, Hyogo (JP); Hiroshi Tanaka, Tokyo (JP); Naoki Yokoi, Tokyo (JP); Yasuhiro Asaoka, Tokyo (JP); Masahiko Higashi, Tokyo (JP)

Correspondence Address: NIXON PEABODY, LLP, 8180 GREENSBORO DRIVE, SUITE 800, MCLEAN, VA, 22102, US

(73) Assignee: MATSUSHITA ELECTRIC INDUSTRIAL CO., LTD., Osaka (JP)

(21) Appl. No.: 10/211,276

(22) Filed: Aug. 5, 2002

(30) Foreign Application Priority Data
Feb. 22, 2002 (JP) 2002-045758

(51) Int. Cl. B08B 3/00; B08B 7/04

(52) U.S. Cl. 134/19; 134/21; 134/30; 134/33; 134/902

(57) ABSTRACT

A cleaning solution is introduced at a working temperature higher than room temperature into a cleaning chamber after the temperature of the inside of the cleaning chamber has been raised by introducing a fluid having a higher temperature than room temperature into the cleaning chamber, or after the temperature of the cleaning chamber has been raised using a heat source, thereby cleaning a semiconductor wafer set in the cleaning chamber.

### BACKGROUND OF THE INVENTION

The present invention relates to a wafer cleaning method that allows, in a semiconductor wafer cleaning step carried out by a semiconductor wafer cleaning system and using a high-temperature liquid chemical, prevention of a temperature drop of the liquid chemical due to heat absorption into a semiconductor wafer, a cleaning chamber or the like, which takes place immediately after wafer cleaning has started. More specifically, the present invention relates to a wafer cleaning method which allows the temperature of the liquid chemical to be kept stable during the cleaning step from start to finish by raising the temperature of the semiconductor wafer by a heated nitrogen gas flow or the like, or by raising the temperature of the cleaning chamber by a heat source.

There are cases in which a cleaning solution having a higher temperature than room temperature (e.g., 35° C. to 40° C. or more) (which will be herein referred to as a high-temperature liquid chemical) is used in a cleaning step of a semiconductor device fabrication process. For example, in many cases, a cleaning step using an organic liquid chemical that has been heated to a temperature in the range from about 35° C. to about 100° C. carried out in forming a pattern of a conducting or insulating film in a semiconductor device with a multilayer interconnection structure. In this manner, a reaction residue that has been produced in forming an interconnection pattern or the like can be removed more effectively than the case of using a liquid chemical at room temperature or below. Moreover, where an organic liquid chemical is used at a set temperature in the range of about 35° C. to about 100° C., the viscosity of the organic liquid chemical decreases, compared to the case in which the organic liquid chemical is used at a lower temperature than the set temperature. Conversely, where the organic liquid chemical is used at a lower temperature than the set temperature, the viscosity of the organic liquid chemical might unwantedly increase markedly.

FIG. 5 is a block diagram illustrating the pipe arrangement in a typical batch wafer spin cleaning system.

As shown in FIG. 5, a wafer cleaning system 100 includes: a cleaning chamber 101 in which semiconductor wafers (not shown) are to be set; a liquid chemical tank 103 in which a liquid chemical 102 is to be retained; a thermometer 104 provided in the liquid chemical tank 103 to measure the temperature of the liquid chemical 102; a heat source 105 provided on an external wall of the liquid chemical tank 103 to raise the temperature of the liquid chemical 102; a pump 106 for applying pressure to the liquid chemical 102 and thereby transferring the liquid chemical 102 from the liquid chemical tank 103 to the cleaning chamber 101; a filter 107 for removing impurities such as particles in the liquid chemical 102; a flow meter 108 for managing the flow rate of the liquid chemical 102; and a valve 109 for changing circulation passages of the liquid chemical 102. The temperature of the liquid chemical 102 retained in the liquid chemical tank 103 is raised to a predetermined working temperature by the heat source 105 using feedback control according to the temperature management of the thermometer 104.

Pressure is applied to the liquid chemical 102 by the pump 106 so as to transfer the liquid chemical 102 from the liquid chemical tank 103 to the filter 107, then to the cleaning chamber 101 via the flow meter 108 and the valve 109. Thereafter, the liquid chemical 102 is discharged via nozzles (not shown) provided in an upper part of the cleaning chamber 101, and is then applied to the semiconductor wafer. Thereafter, the liquid chemical 102 is expelled to the outside of the cleaning chamber 101 through a drain (not shown) provided in a lower part of the cleaning chamber 101, and then returned to the liquid chemical tank 103. In this manner, wafer cleaning is carried out by circulating the liquid chemical 102.

In the batch semiconductor wafer spin cleaning system, for example, a stainless cylindrical case is used as the cleaning chamber 101.

During a wafer cleaning, the valve 109 opens the passage indicated by the solid line in FIG. 5 to allow the stream of the liquid chemical 102 to pass to the cleaning chamber 101 through the passage. When the wafer cleaning system 100 is in a stand-by state, on the other hand, the valve 109 opens the passage, which is indicated by the dotted line, to the liquid chemical tank 103, thereby providing a circulation of the liquid chemical 102 without the flow thereof into the cleaning chamber 101. Accordingly, when the cleaning system is in a stand-by state, except for the cleaning chamber 101 and its neighborhood, all the passages of the liquid chemical 102 can be kept at the same temperature as that of the liquid chemical 102 (i.e., at the predetermined working temperature as described above).

FIG. 6 is a perspective view showing the inside of a cleaning chamber of a typical batch semiconductor wafer spin cleaning system.

As shown in FIG. 6, inside of the cleaning chamber 101, a plurality of the semiconductor wafers 111 (e.g., about 25 wafers) are held by a rotor 112. A motor 113 for rotating the rotor 112 is mounted to a side wall of the cleaning chamber 101, and nozzles 114 for discharging the liquid chemical or the like and a drain 115 for sending back the liquid chemical to the liquid chemical tank are provided in the upper and lower parts of the cleaning chamber 101, respectively. When wafer cleaning is being carried out, the liquid chemical discharged from the nozzles 114 is evenly applied to each of the semiconductor wafers 111 by rotating the rotor 112 by the motor 113. The liquid chemical that has been used to clean each of the semiconductor wafers 111 returns back to the liquid chemical tank again via the drain 115.

FIG. 7 is an illustration showing the inside of the cleaning chamber viewed through the front (i.e., viewed through the left side face of the cleaning chamber 101 of FIG. 6) when semiconductor wafers are being cleaned by a known cleaning method using the batch semiconductor wafer spin cleaning system. In FIG. 7, part of the passage through which a liquid chemical flows and is then discharged via the nozzles into the inside of the cleaning chamber is also shown.

As shown in FIG. 7, a liquid chemical 116 is discharged via the nozzles 114 to each of the semiconductor wafers 111 that are held by the rotor 112. At this point, the liquid chemical 116 is evenly applied to each of the semiconductor wafers 111 by rotating the rotor 112 by the motor (the motor 113 of FIG. 6) mounted on the back face of the cleaning chamber 101 (the right side face of the cleaning chamber 101 of FIG. 6). Individual flows of the liquid chemical 116 that have cleaned and passed each of the semiconductor wafers 111 are gathered in the drain 115 and then returned back to the liquid chemical tank. FIG. 7 shows the case in which the liquid chemical 116 is discharged via the nozzles 114 to clean the semiconductor wafers 111. Not only the liquid chemical 116 but also pure water for water rinsing, or nitrogen for drying or purging, or the like can be discharged via the nozzles 114.

However, if the known wafer cleaning method in which a high-temperature liquid chemical is used is carried out, some problems might be caused. For example, a longer time is required to clean a wafer than expected, or the first semiconductor wafer that is subjected to cleaning immediately after the start of the cleaning step does not become clean enough.

### SUMMARY OF THE INVENTION

In these respects, it is therefore an object of the present invention to prevent the increase in cleaning time and the degradation of cleaning ability in cleaning a wafer using a high-temperature liquid chemical.

In order to achieve this object, the present inventors examined the relation between elapsed time and liquid chemical temperature since cleaning starts in a known wafer cleaning method using a high-temperature liquid chemical. The results of the examination will be shown in FIG. 8. As shown in FIG. 8, although the temperatures of the liquid chemical before and after performing wafer cleaning using the high-temperature liquid chemical (i.e., the temperature of the liquid chemical circulating without passing through the cleaning chamber) were kept constant, the temperature drop of the liquid chemical was observed in performing wafer cleaning, particularly immediately after the cleaning had started. The conclusion that the inventors have reached after the examination on the possible causes for the temperature drop will be described hereafter.

As has been described above, if wafer cleaning was performed by a semiconductor wafer spin cleaning system using the high-temperature liquid chemical, even when the system was in a stand-by state (i.e., when wafer cleaning was not performed), the entire passage of the liquid chemical except for a cleaning chamber was kept at a predetermined working temperature of the liquid chemical. Meanwhile, the cleaning chamber itself was placed at room temperature. Accordingly, as the result of heat absorption from the high-temperature liquid chemical into the cleaning chamber (and its contents such as a semiconductor wafer) that was still placed at room temperature immediately after the start of wafer cleaning, the temperature of the liquid chemical dropped. Specifically, it was confirmed that when the temperature of the liquid chemical before cleaning started (i.e., when the system was in a stand-by state), i.e., when the working temperature of the liquid chemical was predetermined at about 70° C., a temperature drop (ΔT) of about 6° C. to 8° C. was caused immediately after the start of water cleaning.

It was also found that the viscosity increase of the liquid chemical, which had been caused under the influence of the temperature drop of the liquid chemical, led to an increased load on the liquid chemical supply system of the wafer cleaning system and thus resulted in the reduction of the flow rate of the liquid chemical. Specifically, it was confirmed that, when the working temperature of liquid chemical was predetermined at 70° C. and in this condition the liquid chemical caused a temperature drop of about 6° C. to 8° C., the flow rate thereof was reduced by about 10% to 15%. Further, the reduced flow rate of the liquid chemical was found to require a longer cleaning time. And, it was found that the viscosity increase of the liquid chemical due to the temperature drop of the liquid chemical reduced the fluidity of the liquid chemical at the surface of the semiconductor wafer and thus degraded cleaning performance. That is to say, in the wafer cleaning step using the high-temperature liquid chemical, it was found necessary to keep the temperature of the liquid chemical at a predetermined working temperature, i.e., to stabilize the temperature of the liquid chemical from the start to finish of the wafer cleaning, i.e., a liquid chemical processing.

Then, the inventors developed a wafer cleaning method that would allow, in a semiconductor wafer cleaning step carried out by a semiconductor wafer cleaning system and using a high-temperature liquid chemical, prevention of a temperature drop of the liquid chemical due to heat absorption into a semiconductor wafer, a cleaning chamber or the like, which takes place immediately after wafer cleaning has started. In the wafer cleaning step, the temperatures of a cleaning chamber and a semiconductor wafer and the like within the cleaning chamber are raised by a fluid (e.g., a nitrogen gas flow) that is preheated before the wafer cleaning starts, or the temperature of the cleaning chamber is raised by a heat source, so that the temperature drop of the liquid chemical due to heat absorption from the liquid chemical into the semiconductor wafer, the cleaning chamber or the like is prevented. By performing this method, it becomes possible to maintain a stable temperature of the liquid chemical during the cleaning step from start to finish.

Specifically, a first wafer cleaning method according to the present invention includes the steps of: a) introducing a fluid having a higher temperature than room temperature into a cleaning chamber and thereby raising the temperatures of the inside of the cleaning chamber; and b) introducing, into the cleaning chamber whose inside has the raised temperature, a cleaning solution at a predetermined working temperature higher than room temperature and thereby cleaning a semiconductor wafer that is set in the cleaning chamber.

According to the first wafer cleaning method, the temperature of the inside of the cleaning chamber, e.g., the temperature of the semiconductor wafer set within the cleaning chamber is raised by introducing a fluid having a higher temperature than room temperature (which will be herein referred to as a heated fluid) into the chamber before the cleaning solution used at a higher temperature than room temperature, i.e., the high-temperature liquid chemical is introduced to the cleaning chamber. At this time, the temperature of the cleaning chamber can also be raised by the heated fluid. Accordingly, even immediately after the cleaning step using the high-temperature liquid chemical has started, heat absorption from the high-temperature liquid chemical into the semiconductor wafer or the like and into the cleaning chamber can be inhibited, and thus the temperature drop of the liquid chemical can be prevented. As a result, the viscosity increase of the liquid chemical due to the temperature drop of the liquid chemical can be prevented, so that the reduction in the fluidity of the liquid chemical on the surface of the semiconductor wafer can be inhibited and thus degradation of cleaning performance can be prevented. Moreover, the prevention of the increase of the viscosity of the liquid chemical can inhibit the reduction in the flow rate of the liquid chemical, thus preventing the increase in cleaning time taken to clean the semiconductor wafer.

A second wafer cleaning method according to the present invention includes the steps of a) raising the temperature of a cleaning chamber using a heat source; and b) introducing, into the cleaning chamber having the raised temperature, a cleaning solution at a predetermined working temperature higher than room temperature and thereby cleaning a semiconductor wafer that is set in the cleaning chamber.

According to the second wafer cleaning method, the temperature of the cleaning chamber is raised by the heat source before the cleaning solution used at a higher temperature than room temperature, i.e., the high-temperature liquid chemical is introduced into the cleaning chamber. At this time, the temperature of the inside of the cleaning chamber, e.g., the temperature of the semiconductor wafer set within the cleaning chamber can be raised by utilizing radiation heat from a wall surface of the cleaning chamber having a temperature raised by the heat source. Accordingly, even immediately after the cleaning step using the high-temperature liquid chemical has started, heat absorption from the high-temperature liquid chemical into the cleaning chamber that has great heat capacity and into the semiconductor wafer or the like can be inhibited, and thus the temperature drop of the liquid chemical can be prevented effectively. As a result, the viscosity increase of the liquid chemical due to the temperature drop of the liquid chemical can be prevented, so that the reduction in the fluidity of the liquid chemical on the surface of the semiconductor wafer can be inhibited and thus degradation of cleaning performance can be prevented. Moreover, the prevention of the increase in the viscosity of the liquid chemical can inhibit the reduction in the flow rate of the liquid chemical, thus preventing the increase in cleaning time taken to clean the semiconductor wafer.

A third wafer cleaning method according to the present invention includes the steps of a) introducing a fluid having a higher temperature than room temperature into a cleaning chamber and thereby raising the temperature of the inside of the cleaning chamber while raising the temperature of the cleaning chamber using a heat source; and b) introducing, into the cleaning chamber having the raised temperature, a cleaning solution at a predetermined working temperature higher than room temperature and thereby cleaning a semiconductor wafer that is set in the cleaning chamber.

According to the third wafer cleaning method, the temperature of the inside of the cleaning chamber, e.g., the temperature of the semiconductor wafer set within the cleaning chamber is raised by introducing a heated fluid into the chamber and the temperature of the chamber is raised by a heat source at the same time before the cleaning solution used at a higher temperature than room temperature, i.e., the high-temperature liquid chemical is introduced into the cleaning chamber. Accordingly, even immediately after the cleaning step using the high-temperature liquid chemical has started, heat absorption from the high-temperature liquid chemical into the cleaning chamber that has great heat capacity and into the semiconductor wafer or the like can be inhibited, and thus the temperature drop of the liquid chemical can be prevented effectively. As a result, the viscosity increase of the liquid chemical due to the temperature drop of the liquid chemical can be prevented, so that the reduction in the fluidity of the liquid chemical on the surface of the semiconductor wafer can be inhibited and thus degradation of cleaning performance can be prevented. Moreover, the prevention of the increase in the viscosity of the liquid chemical can inhibit the reduction in the flow rate of the liquid chemical, thus preventing the increase in cleaning time taken to clean the semiconductor wafer.

In the first, second and third wafer cleaning method, the semiconductor wafer may be set in the cleaning chamber either before or after the step of raising the temperature of the cleaning chamber or the inside thereof by the heated fluid or the heat source.

In the first or third method, the fluid may be a gas, specifically, an inert gas such as nitrogen, argon, or water vapor, or a reducing gas such as hydrogen. Or the fluid may be a liquid such as water. Note that when the cost, the necessity for a step of diluting the liquid chemical or a step of drying and the like are taken into consideration, nitrogen is most preferable used.

In the first or third wafer cleaning method, the temperature of the fluid is preferably not less than 100° C. and not more than 200° C.

In this manner, the temperature of the inside of the cleaning chamber can surely be raised to a predetermined liquid chemical working temperature (about 35° C. to 100° C.).

In the second or third method, the heat source may be an electric heater, a corrugated pipe which is provided on an external wall of the cleaning chamber and into which a fluid having a higher temperature than room temperature is introduced or the like. In the latter case, a liquid that is to be introduced into the corrugated pipe may be water, an ethylene glycol solution, oil or the like.

In the first, second or third wafer cleaning method, the cleaning chamber is preferably a cleaning chamber of a batch-wafer spin cleaning system or a single-wafer spin cleaning system.

In this manner, effects of each of the methods of the present invention are markedly created, compared to a known wafer cleaning method.

In the first, second or third wafer cleaning method, the cleaning solution is preferably an organic liquid chemical.

In this manner, effects of each of the methods of the present invention are markedly created, compared to a known wafer cleaning method.

### BRIEF DESCRIPTION OF THE DRAWINGS

FIG. 1 is an illustration showing the inside of a cleaning chamber viewed through the front when semiconductor wafers are being cleaned by a wafer cleaning method of a first embodiment of the present invention using a batch semiconductor wafer spin cleaning system.

FIG. 2 is a graph showing the examination results of the relation between elapsed time and liquid chemical temperature since cleaning starts where wafer cleaning with a high-temperature liquid chemical is started after the temperatures of the cleaning chamber and its inside are raised to a predetermined liquid chemical working temperature by any one of the wafer cleaning methods of the first, second and third embodiments.

FIG. 3 is an illustration showing the inside of the cleaning chamber viewed through the front when semiconductor wafers are being cleaned by the wafer cleaning method of the second embodiment using a batch semiconductor wafer spin cleaning system.

FIG. 4 is an illustration showing the inside of the cleaning chamber viewed through the front when semiconductor wafers are being cleaned by the wafer cleaning method of the third embodiment using a batch semiconductor wafer spin cleaning system.

FIG. 5 is a block diagram illustrating an example of pipe arrangements for the batch wafer spin cleaning system for use in the wafer cleaning methods of the first, second and third embodiments.

FIG. 6 is a perspective view showing an example of the inside of a cleaning chamber for a batch wafer spin cleaning system for use in the wafer cleaning methods of the first, second and third embodiments.

FIG. 7 is an illustration showing the inside of a cleaning chamber viewed through the front when semiconductor wafers are being cleaned by a known wafer cleaning method using a batch semiconductor wafer spin cleaning system.

FIG. 8 is a graph showing the relation between elapsed time and liquid chemical temperature since cleaning starts in the known wafer cleaning method using a high-temperature liquid chemical.

### DESCRIPTION OF THE PREFERRED EMBODIMENTS

(First Embodiment)

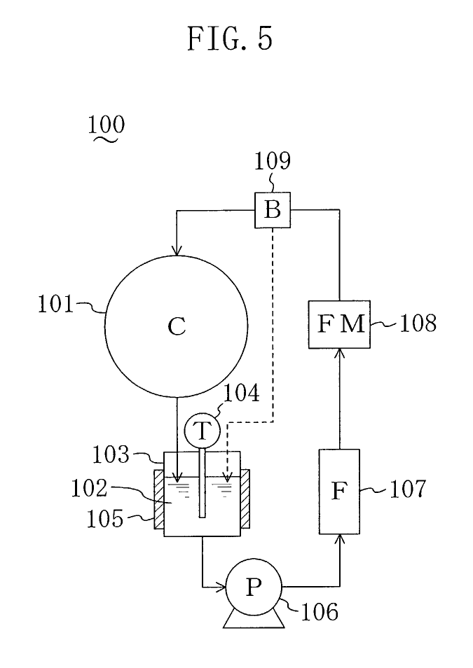

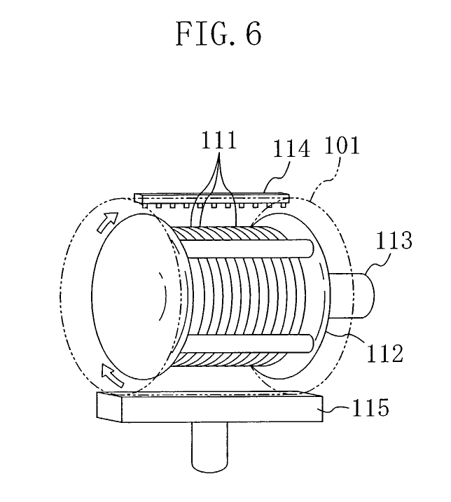

Hereinafter, a wafer cleaning method in accordance with a first embodiment of the present invention will be described with reference to the accompanying drawings by employing as an example the case in which a high-temperature liquid chemical is used in a batch semiconductor wafer spin cleaning system shown in FIGS. 5 and 6 that is used as a wafer cleaning system.

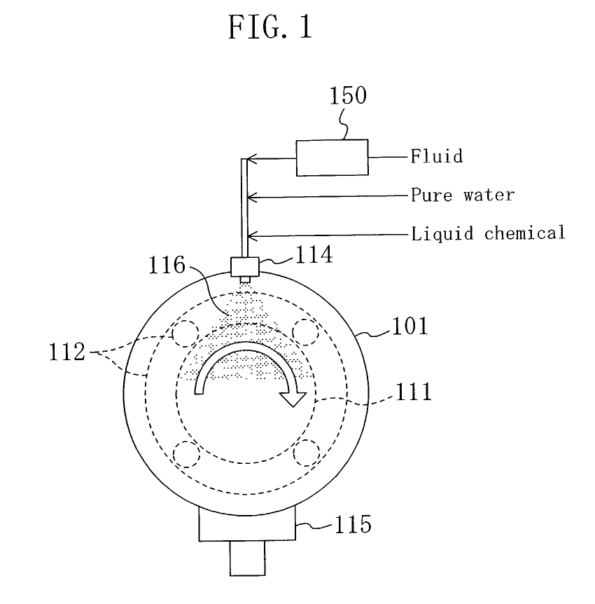

FIG. 1 is an illustration showing the inside of a cleaning chamber viewed through the front (i.e., viewed through the left side face of the cleaning chamber 101 of FIG. 6) when semiconductor wafers are being cleaned by the wafer cleaning method in accordance with the first embodiment using the batch semiconductor wafer spin cleaning system. In FIG. 1, part of the passage through which a liquid chemical flows and is then discharged via the nozzles into the cleaning chamber is also shown.

As shown in FIG. 1, a plurality of semiconductor wafers 111 (e.g., about 25 wafers) are held by a rotor 112 within a cleaning chamber 101. When the wafers are being cleaned, a liquid chemical 116 is discharged to each of the semiconductor wafers 111 via nozzles 114 that are provided in the upper part of the cleaning chamber 101. During the wafer cleaning, the rotor 112 is rotated by a motor (the motor 113 of FIG. 6) which is mounted on the back face of the cleaning chamber 101 (i.e., on the right side face of the cleaning chamber 101 of FIG. 6) such that the liquid chemical 116 is evenly applied to each of the semiconductor wafers 111. Individual flows of the liquid chemical 116 that have cleaned and then passed each of the semiconductor wafers 111 are collected in a drain 115 and then returned to the liquid chemical tank. The case in which the liquid chemical 116 is discharged via the nozzles 114 so as to clean the semiconductor wafers 111 is shown in FIG. 1. However, not only the liquid chemical 116 but also pure water for water rinsing, or nitrogen for drying or purging, or the like can be discharged via the nozzles 114.

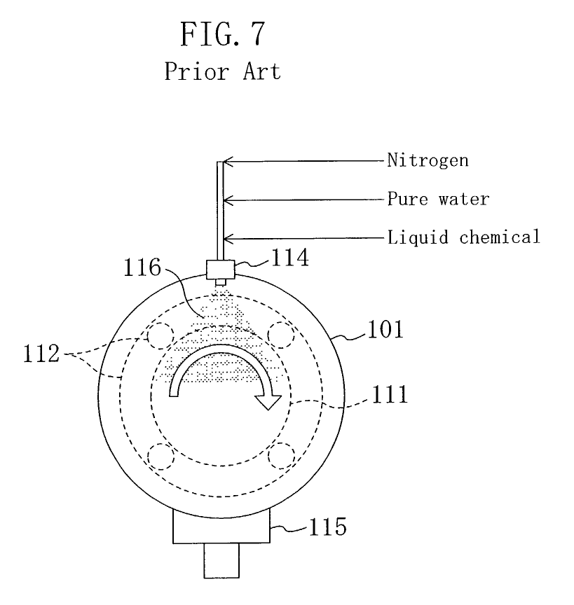

The point in which the wafer cleaning system used in the wafer cleaning method of the first embodiment differs from the known example of FIG. 7 is that, as shown in FIG. 1, a heating device 150 is mounted on the passage through which a fluid flows and is then discharged via the nozzles 114 such that the fluid can be heated to a temperature of about 100° C. to about 200° C.

Then, a characteristic of the wafer cleaning method of the first embodiment is that the fluid heated to a temperature of about 100° C. to about 200° C. by the heating device 150 (which will be herein referred to as a heated fluid) is discharged via the nozzles 114 before the cleaning step using the high-temperature liquid chemical is started, i.e., before the high-temperature liquid chemical is introduced to the cleaning chamber 101. Accordingly, the temperature of the cleaning chamber 101 containing the semiconductor wafer 111, the rotor 112 and the like can be raised from room temperature to a desired temperature, e.g., to a predetermined working temperature of the liquid chemical. The rotor 112 is preferably rotated at a rotation speed in the range of about 10 rpm to about 1000 rpm in order that each of the semiconductor wafers 111 can be heated evenly in its surface.

According to the first embodiment, the temperatures of the cleaning chamber 101, the semiconductor wafer 111 and the like within the cleaning chamber 101 are raised by introducing the heated fluid into the chamber 101 before the high-temperature liquid chemical is introduced to the cleaning chamber 101. Accordingly, even immediately after the wafer cleaning step using the high-temperature liquid chemical has started, heat absorption from the high-temperature liquid chemical into the semiconductor wafer 111 or the like and into the cleaning chamber 101 can be inhibited, and thus the temperature drop of the liquid chemical can be prevented. As a result, the viscosity increase of the liquid chemical due to the temperature drop of the liquid chemical can be prevented, so that the reduction in the fluidity of the liquid chemical on the surface of the semiconductor wafer 111 can be inhibited. Therefore, degradation of cleaning performance can be prevented. Moreover, the prevention of the viscosity increase of the liquid chemical can inhibit the reduction in the flow rate of the liquid chemical, thus preventing the increase in cleaning time taken to clean the semiconductor wafers 111.

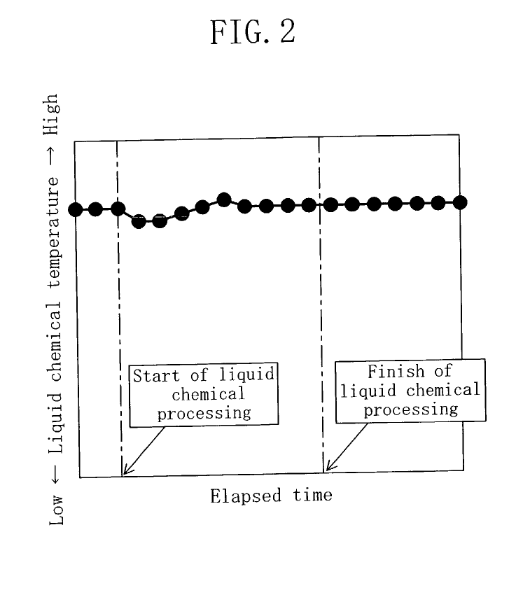

FIG. 2 shows the results of the examination of the relation between elapsed time and liquid chemical temperature since cleaning starts where a wafer cleaning step by the wafer cleaning method of the first embodiment using a high-temperature liquid chemical is started after the temperatures of a cleaning chamber 101, a semiconductor wafer 111 and the like have been raised to a predetermined working temperature of the liquid chemical.

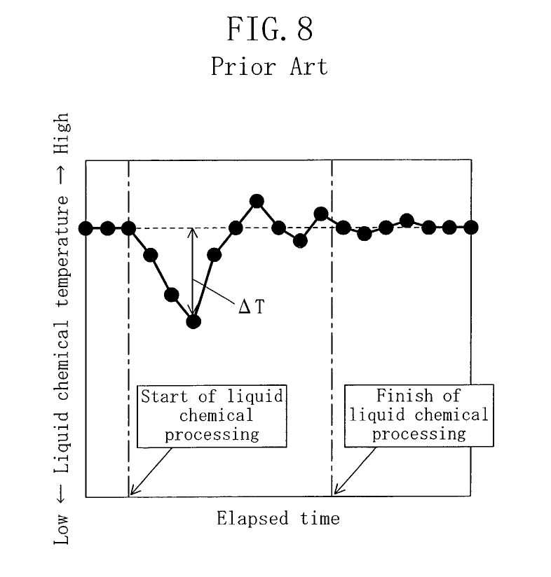

As shown in FIG. 2, in the first embodiment, the temperature drop of the liquid chemical was hardly observed immediately after the wafer cleaning had started, while in the known wafer cleaning method, changes in the temperature of the liquid chemical with time were observed as shown in FIG. 8. Thus, it was confirmed that changes in the temperature of the liquid chemical from start to finish of the wafer cleaning step using the high-temperature liquid chemical were very small in the first embodiment. That is to say, it was confirmed that the temperature of the liquid chemical could be kept stable during the wafer cleaning from start to finish, by raising the temperatures of the cleaning chamber 101, the semiconductor wafer 111, the rotor 112 and the like within the chamber to a predetermined working temperature of the liquid chemical with the fluid heated by the heating device 150. At this time, it was also confirmed that the flow rate of the liquid chemical had a small decline of about 2% at most due to the temperature drop of the liquid chemical. Further, in the first embodiment, the temperature of the liquid chemical is kept substantially at a constant temperature (i.e., at the predetermined liquid chemical working temperature) before and after the wafer cleaning using the high-temperature liquid chemical is carried out, as shown in FIG. 2.

In the first embodiment, where the predetermined liquid chemical working temperature is 70° C. and nitrogen heated to about 100° C. to about 200° C. was used as the heated fluid, the time for which the temperatures of the cleaning chamber 101 and its inside continued to be raised to maintain the behavior of the liquid chemical temperature shown in FIG. 2, i.e., the time required to raise the temperatures of the cleaning chamber 101 and its inside from room temperature to 70° C. using the heated fluid, was about 5 to 10 minutes.

(Second Embodiment)

Hereinafter, a wafer cleaning method according to a second embodiment of the present invention will be described with reference to the accompanying drawings by employing as an example the case in which a high-temperature liquid chemical is used in a batch semiconductor wafer spin cleaning system shown in FIGS. 5 and 6 that is used as a wafer cleaning system.

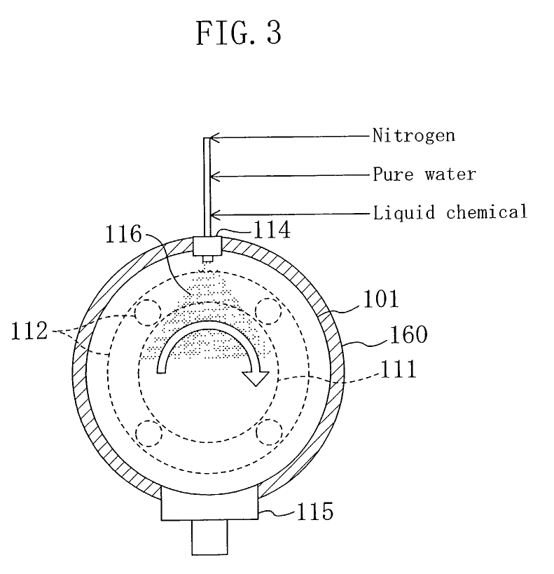

FIG. 3 is an illustration showing the inside of a cleaning chamber viewed through the front (i.e., viewed through the left side face of the cleaning chamber 101 of FIG. 6) when semiconductor wafers are being cleaned by the wafer cleaning method in accordance with the second embodiment using the batch semiconductor wafer spin cleaning system. In FIG. 3, part of the passage through which a liquid chemical flows and is then discharged via the nozzles into the cleaning chamber is also shown.

As shown in FIG. 3, a plurality of semiconductor wafers 111 (e.g., about 25 wafers) are held by a rotor 112 within a cleaning chamber 101. When the wafers are being cleaned, a liquid chemical 116 is discharged to each of the semiconductor wafers 111 via nozzles 114 that are provided in the upper part of the cleaning chamber 101. During the wafer cleaning, the rotor 112 is rotated by a motor (the motor 113 of FIG. 6) which is mounted on the back face of the cleaning chamber 101 (i.e., on the right side face of the cleaning chamber 101 of FIG. 6) such that the liquid chemical 116 is evenly applied to each of the semiconductor wafers 111. Individual flows of the liquid chemical 116 that have cleaned and then passed each of the semiconductor wafers 111 are collected in a drain 115 and then returned to the liquid chemical tank. The case in which the liquid chemical 116 is discharged via the nozzles 114 so as to clean the semiconductor wafers 111 is shown in FIG. 3. However, not only the liquid chemical 116 but also pure water for water rinsing, or nitrogen for drying or purging, or the like can be discharged via the nozzles 114.

The point in which the cleaning system used in the wafer cleaning method of the second embodiment differs from the known example of FIG. 7 is that, as shown in FIG. 3, a heat source 160, such as an electric heater, is mounted on an external wall of the cleaning chamber 101 such that the cleaning chamber 101 can be heated to a desired temperature.

Then, a characteristic of the wafer cleaning method of the second embodiment is that the cleaning chamber 101 is preheated to and kept at a desired temperature, e.g., a predetermined working temperature of the liquid chemical by the heat source 160 whether the cleaning step using a high-temperature liquid chemical is performed or not, i.e., whether the system is in an operation state or stand-by state. Accordingly, it is possible to keep the contents and inner parts of the cleaning chamber 101, e.g., the semiconductor wafer 111 and the rotor 112 at, e.g., a predetermined working temperature of the liquid chemical by utilizing radiation heat from a wall surface of the heated cleaning chamber 101 before the liquid chemical is introduced to the cleaning chamber 101, i.e., before the system starts its operation. In this case, the rotor 112 is preferably rotated at a rotation speed in the range of about 10 rpm to 1000 rpm in order that each of the semiconductor wafers 111 can be heated evenly in its surface.

According to the second embodiment, the temperature of the cleaning chamber 101 is raised by the heat source 160 both when the system is in an operation state and when in a stand-by state, and at the same time the temperature of the inside of the cleaning chamber 101, e.g., the temperature of the semiconductor wafer 111 set within the cleaning chamber 101, is raised by utilizing the radiation heat from the wall surface of the heated cleaning chamber 101 before the system starts its operation. Accordingly, even immediately after the cleaning step using the high-temperature liquid chemical has started, heat absorption from the high-temperature liquid chemical into the cleaning chamber 101 that has great heat capacity and into the semiconductor wafer 111 or the like can be inhibited, and thus the temperature drop of the liquid chemical can be prevented. As a result, the viscosity increase of the liquid chemical due to the temperature drop of the liquid chemical can be prevented, so that the reduction in the fluidity of the liquid chemical on the surface of the semiconductor wafer 111 can be inhibited. Therefore, degradation of cleaning performance can be prevented. Moreover, the prevention of the viscosity increase of the liquid chemical can inhibit the reduction in the flow rate of the liquid chemical, thus preventing the increase in cleaning time taken to clean the semiconductor wafers 111.

FIG. 2 shows the results of the examination of the relation between elapsed time and liquid chemical temperature since cleaning starts where a wafer cleaning step by the wafer cleaning method of the second embodiment using a high-temperature liquid chemical is started after the temperatures of a cleaning chamber 101, a semiconductor wafer 111 and the like have been raised to a predetermined working temperature of the liquid chemical, as well as those in the case of the first embodiment.

As shown in FIG. 2, in the second embodiment, the temperature drop of the liquid chemical was also hardly observed immediately after the cleaning had started, while in the known wafer cleaning method, changes in the temperature of the liquid chemical with time were observed as shown in FIG. 8. Thus, it was confirmed that changes in the temperature of the liquid chemical from start to finish of the wafer cleaning step using the high-temperature liquid chemical were very small. That is to say, it was confirmed that the liquid chemical can be kept at a stable temperature during the wafer cleaning from start to finish, by raising the temperature of the cleaning chamber 101 and keeping it at a predetermined liquid chemical working temperature by the heat source 160 both when the system is in an operation state and when in a stand-by state and at the same time by raising the temperature of the inside of the cleaning chamber 101 and keeping it at a predetermined working temperature of the liquid chemical by utilizing the radiation heat from the wall surface of the heated cleaning chamber 101 before the system starts its operation. At this time, it was also confirmed that the flow rate of the liquid chemical had a small decline of about 2% at most due to the temperature drop of the liquid chemical. Further, as shown in FIG. 2, in the second embodiment, the temperature of the liquid chemical is kept substantially at a constant temperature (i.e., at the predetermined liquid chemical working temperature) before and after the wafer cleaning using the high-temperature liquid chemical is carried out.

In the second embodiment, where the predetermined liquid chemical working temperature is 70° C., the time for which the temperatures of the cleaning chamber 101 and its inside continued to be raised so as to maintain the behavior of the liquid chemical temperature shown in FIG. 2, i.e., the time required to raise the temperatures of the cleaning chamber 101 and its inside from room temperature to 70° C. using the heat source 160, was about 2 to 5 minutes. In the second embodiment, although the temperatures of the semiconductor wafer 111, the rotor 112 and the like are not directly raised by, e.g., the heated nitrogen as used in the first embodiment, it took a relatively short time to raise the temperatures to the desired degree so as to maintain the behavior of the liquid chemical temperature, i.e., to stabilize the temperature of the liquid chemical. The reason for this is that the temperature of the cleaning chamber 101 having a greater heat capacity than the semiconductor wafer 111 and the like is raised by the heat source 160. That is to say, in general, a case to be the cleaning chamber 101 has a thick-wall structure so as to ensure durability against vibration generated by the rotation of the rotor 112 and the like. This is a big factor causing the cleaning chamber 101 to absorb heat from the high-temperature liquid chemical. Accordingly, raising the temperature of the cleaning chamber 101 using the heat source 160 is effective at shortening the time required to stabilize the temperature of the liquid chemical.

(Third Embodiment)

Hereinafter, a wafer cleaning method according to a third embodiment of the present invention will be described with reference to the accompanying drawings by employing as an example the case in which a high-temperature liquid chemical is used in a batch semiconductor wafer spin cleaning system shown in FIGS. 5 and 6 that is used as a wafer cleaning system.

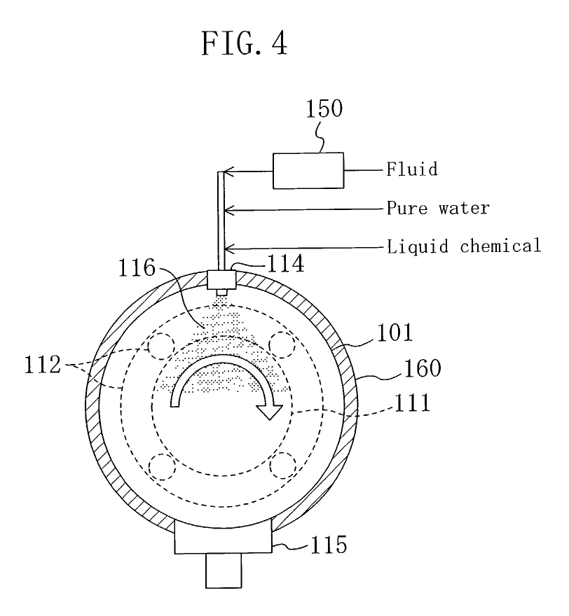

FIG. 4 is an illustration showing the inside of a cleaning chamber viewed through the front (i.e., viewed through the left side face of the cleaning chamber 101 of FIG. 6) when semiconductor wafers are being cleaned by the wafer cleaning method in accordance with the third embodiment using the batch semiconductor wafer spin cleaning system. In FIG. 4, part of the passage through which a liquid chemical flows and is then discharged by the nozzles into the cleaning chamber is also shown.

As shown in FIG. 4, a plurality of semiconductor wafers 111 (e.g., about 25 wafers) are held by a rotor 112 within a cleaning chamber 101. When the wafers are being cleaned, a liquid chemical 116 is discharged to each of the semiconductor wafers 111 via nozzles 114 that are provided in the upper part of the cleaning chamber 101. During the wafer cleaning, the rotor 112 is rotated by a motor (the motor 113 of FIG. 6) which is mounted on the back face of the cleaning chamber 101 (i.e., on the right side face of the cleaning chamber 101 of FIG. 6) such that the liquid chemical 116 is evenly applied to each of the semiconductor wafers 111. Individual flows of the liquid chemical 116 that have cleaned and then passed each of the semiconductor wafers 111 are collected in a drain 115 and then returned to the liquid chemical tank. The case in which the liquid chemical 116 is discharged via the nozzles 114 so as to clean the semiconductor wafers 111 are shown in FIG. 4. However, not only the liquid chemical 116 but also pure water for water rinsing, or nitrogen for drying or purging, or the like can be discharged via the nozzles 114.

The point in which the cleaning system used in the wafer cleaning method of the third embodiment differs from the known example of FIG. 7 is that, as shown in FIG. 4, a heating device 150 is mounted on the passage through which a fluid flows and is then discharged via the nozzles 114 such that the fluid can be heated to a temperature of about 100° C. to about 200° C., and that a heat source 160, such as an electric heater, is mounted on an external wall of the cleaning chamber 101 such that the cleaning chamber 101 can be heated to a desired temperature.

Then, a characteristic of the wafer cleaning method of the third embodiment is that the cleaning chamber 101 is preheated to and kept at a desired temperature, e.g., a predetermined working temperature of the liquid chemical by the heat source 160 both when a cleaning step using a high-temperature liquid chemical is performed and when not, i.e., both when the system is in an operation state and when in a stand-by state. Another characteristic of the wafer cleaning method of the third embodiment is that the fluid heated to a temperature of about 100° C. to about 200° C. by the heating device 150 is discharged via the nozzles 114 before the high-temperature liquid chemical is introduced into the cleaning chamber 101, i.e., before the system starts its operation. Accordingly, it is possible to raise the temperature of the semiconductor wafer 111, the rotor 112 and the like within the cleaning chamber 101 from room temperature to a desired temperature, e.g., a predetermined working temperature of the liquid chemical. In this case, the rotor 112 is preferably rotated at a rotation speed in the range of about 10 rpm to 1000 rpm in order that each of the semiconductor wafers 111 can be heated evenly in its surface.

According to the third embodiment, the temperature of the cleaning chamber 101 is raised by the heat source 160 both when the system is in an operation state and when in a stand-by state, and at the same time the temperatures of the semiconductor wafer 111 and the like within the cleaning chamber 101 are raise by introducing the heated fluid into the cleaning chamber 101 before the system starts its operation. Accordingly, even immediately after the cleaning step using the high-temperature liquid chemical has started, heat absorption from the high-temperature liquid chemical into the cleaning chamber 101 that has great heat capacity and into the semiconductor wafer 111 or the like can be inhibited, and thus the temperature drop of the liquid chemical can be prevented. As a result, the viscosity increase of the liquid chemical due to the temperature drop of the liquid chemical can be prevented, so that the reduction in the fluidity of the liquid chemical on the surface of the semiconductor wafer 111 can be inhibited. Therefore, the degradation of cleaning performance can be prevented. Moreover, the prevention of the viscosity increase of the liquid chemical can inhibit the reduction in the flow rate of the liquid chemical, thus preventing the increase in cleaning time taken to clean the semiconductor wafer 111.

FIG. 2 shows the results of the examination of the relation between elapsed time and liquid chemical temperature since cleaning starts where a wafer cleaning step by the wafer cleaning method of the third embodiment using a high-temperature liquid chemical is started after the temperatures of a cleaning chamber 101, a semiconductor wafer 111 and the like have been raised to a predetermined working temperature of the liquid chemical, as well as those in the case of the first embodiment.

As shown in FIG. 2, in the third embodiment, the temperature drop of the liquid chemical was also hardly observed immediately after the cleaning had started, while in the known wafer cleaning method, changes in the temperature of the liquid chemical with time were observed as shown in FIG. 8. Thus, it was confirmed that changes in the temperature of the liquid chemical from start to finish of the wafer cleaning step using the high-temperature liquid chemical were very small. That is to say, it was confirmed that the liquid chemical can be kept at a stable temperature from start to finish of the cleaning, by raising the temperature of the cleaning chamber 101 and keeping it at a predetermined liquid chemical working temperature by the heat source 160 both when the system is in an operation state and when in a stand-by state and at the same time by raising the temperature of the inside of the cleaning chamber 101 and keeping it at a predetermined working temperature of the liquid chemical by the fluid heated by the heating device 150 before the system starts its operation. At this time, it was also confirmed that the flow rate of the liquid chemical had a small decline of about 2% at most due to the temperature drop of the liquid chemical. Further, as shown in FIG. 2, in the third embodiment, the temperature of the liquid chemical is kept substantially at a constant temperature (i.e., at the predetermined liquid chemical working temperature) before and after the wafer cleaning using the high-temperature liquid chemical is carried out.

In the third embodiment, where the predetermined liquid chemical working temperature is 70° C. and nitrogen heated to about 100° C. to about 200° C. was used as the heated fluid, the time for which the temperatures of the cleaning chamber and its inside continued to be raised so as to maintain the behavior of the liquid chemical temperature shown in FIG. 2, i.e., the time required to raise the temperatures of the cleaning chamber 101 and its inside from room temperature to 70° C. using the heated fluid and the heat source 160, was about 30 seconds to 2 minutes.

Table 1 shows the results of the evaluations of the stability of the liquid chemical temperature, the time required to stabilize the behavior of the liquid chemical temperature (i.e., the time for which the temperatures of the cleaning chamber and its inside continued to be raised to maintain the behavior of the liquid chemical temperature shown in FIG. 2 before a wafer cleaning step was started), and how fast the inside of the cleaning chamber was dried in the cases where the wafer cleaning methods of the first, second and third embodiments of the present invention were used. In Table 1, the evaluation results for the above-described items obtained where a known wafer cleaning method was used are also shown as a comparative example, as well as the results obtained by comprehensively evaluating each of the wafer cleaning methods according to the first, second and third embodiments of the present invention and the known wafer cleaning method. In Table 1, as for the “how fast the inside of chamber is dried” in the wafer cleaning methods of the first and third embodiments, the evaluation results obtained where nitrogen was used as the heated fluid are shown.

TABLE 1

| | | Time required | How fast | |
|---|---|---|---|---|
| | | to stabilize | the inside | |
| | Stability of | behavior of | of | |
| Cleaning | liquid chemical | liquid chemical | chamber is | Overall |
| method | temperature | temperature | dried | evaluation |
| Comparative | X | — | X | X |
| example | | | | |
| First | ◯ | 5 to 10 min. | ◯ | ◯ |
| embodiment | | | | |
| Second | ◯ | 2 to 5 min. | Δ | ◯ |
| embodiment | | | | |
| Third | ◯ | 30 sec. to 2 min. | ⊚ | ⊚ |
| embodiment | | | | |

⊚: Excellent
◯: Good
Δ: poor
X: very poor

Note that in the first or third embodiment, nitrogen is used as a heated fluid, a heated fluid applicable for the present invention is not limited to nitrogen but another gas or liquid that does not have adverse effects, such as corrosion, in the semiconductor wafer 111, the cleaning chamber 101 or the like, may be used as a heated fluid. Specifically, an inert gas, besides nitrogen, e.g., helium, neon, argon, krypton, water vapor or the like may be used as a heated fluid. Alternatively, as a heated fluid, a reducing gas, e.g., hydrogen, may be used with an inert gas or a liquid, e.g., water may be used. However, when the cost, the necessity for a step of diluting the liquid chemical or a step of drying, and the like are taken into consideration, nitrogen is most preferably used as a heated fluid. Moreover, when hydrogen is used as a heat fluid, a secondary beneficial effect that copper oxide can be reduced in a Cu process can be obtained.

Furthermore, in the first or third embodiment, nitrogen, which is used for drying or purging in the cleaning chamber 101, is used also as a heated fluid. However, nitrogen may be used for drying or purging, together with another gas or liquid that is used as a heated fluid instead. In this case, passages through which the heated fluid and nitrogen respectively flow to the nozzles 114 may be provided independently of each other, or the passages may be provided so as to merge into one passage at a selector valve provided immediately before the heating device 150 so that the heated fluid and nitrogen share the passage to the nozzles.

Furthermore, in the second or third embodiment, the heat source 160 for raising the temperature of the cleaning chamber 101 is not limited to a specific type. For example, there may be used as the heat source the electric heater provided on the external wall of the cleaning chamber 101, a corrugated pipe, provided on the external wall of the cleaning chamber 101, into which a liquid with a higher temperature than room temperature is introduced, or the like. In these cases, where the cleaning chamber 101 has a thick wall, the electric heater, the corrugated pipe, or the like may be provided in the wall. Also, water, an ethylene glycol solution, oil, or the like may be used as the liquid that is to be introduced into the corrugated pipe. Further, the heat source 160 is not necessarily provided in face-to-face contact with the cleaning chamber 101. The heat source 160, e.g., an infrared heater may be provided a predetermined distance apart from the cleaning chamber 101 so as to raise the temperature of the cleaning chamber 101.

Furthermore, in the second or third embodiment, the temperature of the cleaning chamber 101 is raised by the heat source 160 both when the system is in an operation state and when in a stand-by state, and thereby the temperature of the inside of the cleaning chamber 101 is raised by utilizing radiation heat from the wall surface of the heated cleaning chamber 101 before the system starts its operation. However, the temperature of the cleaning chamber 101 does not have to be raised by the heat source 160 when the system is in an operation state. Also when the system is in a stand-by state, the temperature of the cleaning chamber 101 does not have to be raised by the heat source 160 for all the time. The temperature of the cleaning chamber 101 may be raised by the heat source 160, e.g., before the system starts its operation, i.e., the high-temperature liquid chemical is introduced into the cleaning chamber 101 so that the inside of the cleaning chamber 101 is kept at a raised temperature. However, when the time required to stabilize the temperature of the cleaning chamber 101 heated by the heat source 160 is taken into consideration, it is preferable to raise the temperature of the cleaning chamber 101 by heat source 160 when the system is in a stand-by state, or for a predetermined period of time before the system starts its operation.

Furthermore, in the first, second and third embodiments, although the semiconductor wafers 111 are preferably set in the cleaning chamber 101 before the step of raising the temperatures of the cleaning chamber 101 and its inside using the heated fluid or the heat source 160 is carried out, the semiconductor wafers 111 may be set in the cleaning chamber 101 after the temperature raising step has been carried out.

Furthermore, in the first, second and third embodiments, it is the most preferable to raise the temperatures of the cleaning chamber 101 and its inside from room temperature to a predetermined liquid chemical working temperature by the heated fluid or the heat source 160 before the high-temperature liquid chemical is introduced to the cleaning chamber 101. However, if the temperatures of the cleaning chamber 101 and its inside are raised to not so much as the predetermined liquid chemical working temperature but to a higher temperature than room temperature, the effect of preventing the increase in cleaning time and degradation of cleaning performance can be obtained according to how much the temperatures are raised, unlike the known wafer cleaning method.

Furthermore, in the first, second and third embodiments, it is assumed that the batch semiconductor wafer spin cleaning system shown in FIGS. 5 and 6 is used. Instead of this system, however, other types of batch semiconductor wafer spin cleaning systems or various types of single semiconductor wafer spin cleaning systems may be used. Where such batch or single semiconductor wafer spin cleaning systems are used in the first, second and third embodiments, the effect of each of the embodiments, i.e., the effect of preventing the increase in cleaning time and degradation of cleaning performance is notably exhibited.

In a bath type semiconductor wafer cleaning system (for batch processing), a liquid chemical circulates through a cleaning bath when the system is in a stand-by state, and thus no heat absorption from the high-temperature liquid chemical into the cleaning bath occurs after a cleaning process using the high-temperature liquid chemical starts. On the other hand, in the stand-by state, a wafer cassette which holds semiconductor wafers may be removed from the cleaning bath and the wafer cassette may be placed at room temperature. In such a case, by preheating the wafer cassette containing the semiconductor wafers before a cleaning process using the high-temperature liquid chemical starts, or by setting the temperature of the liquid chemical circulating when the system is in a stand-by state at a higher temperature than a predetermined working temperature of the liquid chemical, the increase in cleaning time and degradation of cleaning performance can be prevented.

In the first, second and third embodiments, the high-temperature liquid chemical is not particularly limited to a specific kind. However, when an organic liquid chemical is used as the high-temperature liquid chemical, the effect of each of the embodiments, i.e., the effect of preventing the increase in cleaning time and degradation of cleaning performance is notably exhibited.

What is claimed is:

1. A wafer cleaning method, comprising the steps of:
a) introducing a fluid having a higher temperature than room temperature into a cleaning chamber and thereby raising the temperatures of the inside of the cleaning chamber; and
b) introducing, into the cleaning chamber whose inside has the raised temperature, a cleaning solution at a predetermined working temperature higher than room temperature and thereby cleaning a semiconductor wafer that is set in the cleaning chamber.

2. The wafer cleaning method of claim 1, wherein the fluid is a gas.

3. The wafer cleaning method of claim 2, wherein the gas is an inert gas.

4. The wafer cleaning method of claim 3, wherein the inert gas is nitrogen or argon.

5. The wafer cleaning method of claim 3, wherein the inert gas is water vapor.

6. The wafer cleaning method of claim 2, wherein the gas is a reducing gas.

7. The wafer cleaning method of claim 1, wherein the fluid is a liquid.

8. The wafer cleaning method of claim 7, wherein the liquid is water.

9. The wafer cleaning method of claim 1, wherein the temperature of the fluid is not less than 100° C. and not more than 200° C.

10. The wafer cleaning method of claim 1, wherein the cleaning chamber is a cleaning chamber of a batch-wafer spin cleaning system or a single-wafer spin cleaning system.

11. The wafer cleaning method of claim 1, wherein the cleaning solution is an organic liquid chemical.

12. A wafer cleaning method, comprising the steps of:
a) raising the temperature of a cleaning chamber using a heat source; and
b) introducing, into the cleaning chamber having the raised temperature, a cleaning solution at a predetermined working temperature higher than room temperature and thereby cleaning a semiconductor wafer that is set in the cleaning chamber.

13. The wafer cleaning method of claim 12, wherein the heat source is an electric heater.

14. The wafer cleaning method of claim 12, wherein the heat source is a corrugated pipe which is provided on an external wall of the cleaning chamber and into which a fluid having a higher temperature than room temperature is to be introduced.

15. The wafer cleaning method of claim 14, wherein the fluid that is to be introduced into the corrugated rube is water, an ethylene glycol solution or oil.

16. The wafer cleaning method of claim 12, wherein the cleaning chamber is a cleaning chamber of a batch-wafer spin cleaning system or a single-wafer spin cleaning system.

17. The wafer cleaning method of claim 12, wherein the cleaning solution is an organic liquid chemical.

18. A wafer cleaning method, comprising the steps of:
a) introducing a fluid having a higher temperature than room temperature into a cleaning chamber and thereby raising the temperature of the inside of the cleaning chamber while raising the temperature of the cleaning chamber using a heat source; and
b) introducing, into the cleaning chamber having the raised temperature, a cleaning solution at a predetermined working temperature higher than room temperature and thereby cleaning a semiconductor wafer that is set in the cleaning chamber.

19. The wafer cleaning method of claim 18, wherein the fluid is a gas.

20. The wafer cleaning method of claim 19, wherein the gas is an inert gas.

21. The water cleaning method of claim 20, wherein the inert gas is nitrogen or argon.

22. The wafer cleaning method of claim 20, wherein the inert gas is water vapor.

23. The wafer cleaning method of claim 19, wherein the gas is a reducing gas.

24. The wafer cleaning method of claim 18, wherein the fluid is a liquid.

25. The wafer cleaning method of claim 24, wherein the fluid is water.

26. The wafer cleaning method of claim 18, wherein the temperature of the fluid is not less than 100° C. and not more than 200° C.

27. The wafer cleaning method of 18, wherein the heat source is an electric heater.

28. The wafer cleaning method of 18, wherein the heat source is a corrugated pipe which is provided on an external wall of the cleaning chamber and into which a fluid having a higher temperature than room temperature is to be introduced.

29. The wafer cleaning method of 28, wherein the liquid that is to be introduced into the corrugated pipe is water, an ethylene glycol solution or oil.

30. The wafer cleaning method of claim 18, wherein the cleaning chamber is a cleaning chamber of a batch-wafer spin cleaning system or a single-wafer spin cleaning system.

31. The wafer cleaning method of claim 18, wherein the cleaning solution is an organic liquid chemical.
